(19) United States
(12) Patent Application Publication
(10) Pub. No.: US 2022/0397157 A1
(43) Pub. Date: Dec. 15, 2022

(54) Encoder for a wheel bearing, and wheel bearing having an encoder of this type

(71) Applicant: Schaeffler Technologies AG & Co. KG, Herzogenaurach (DE)

(72) Inventors: Christian Mock, Schweinfurt (DE); Christian Huelz, Oberschwappach (DE); Marco Krapf, Burkardroth (DE); Branko Katana, Herzogenaurach (DE)

(73) Assignee: Schaeffler Technologies AG & Co. KG, Herzogenaurach (DE)

(21) Appl. No.: 17/776,058

(22) PCT Filed: Nov. 3, 2020
(86) PCT No.: PCT/DE2020/100937

§ 371 Date: May 11, 2022

(30) Foreign Application Priority Data
Dec. 13, 2019 (DE) 10 2019 134 246.5

(51) Int. Cl. F16C 41/00; F16C 19/38

(52) U.S. Cl. CPC F16C 41/007; F16C 19/38; F16C 2326/02

(57) ABSTRACT

An encoder for a wheel bearing includes a carrier plate ring and a magnetic encoding ring. The carrier plate ring has a radially running first leg, and an axially running second leg arranged on an outer ring or on an inner ring of the wheel bearing. The carrier plate ring has, on the radially running first leg, cut-outs distributed over its circumference. The first leg has a fold for forming a folded portion, and the folded portion at least partly covers the cut-outs. The carrier plate ring is at least partly surrounded by the magnetic encoding ring. The encoding ring has unipolar magnetization and at least partly comes into contact in the cut-outs.

### CROSS-REFERENCE TO RELATED APPLICATIONS

This application is the United States National Phase of PCT Appln. No. PCT/DE2020/100937 filed Nov. 3, 2020, which claims priority to German Application No. DE102019134246.5 filed Dec. 13, 2019, the entire disclosures of which are incorporated by reference herein.

### TECHNICAL FIELD

The present disclosure relates to an encoder for a wheel bearing, in particular for a rolling ball bearing. Furthermore, the disclosure relates to a wheel bearing with an encoder of this type.

### BACKGROUND

EP 0 892 185 A2, for example, shows a seal with integrated encoder mounted between a fixed support and a rotating support of a rolling bearing or a bearing. The seal has a mobile frame with a disc. The magnetic encoding element is supported by the disc and formed by an elastomer loaded with magnetic particles that covers the outside of the disc. Furthermore, the magnetic encoding element carries a radial outer sealing lip attached to the disc and resting on the rotating support, and the disc is fixedly attached to a cylindrical support surface placed on the mobile support. The magnetic encoding element also carries an axi-radial lip that is in contact with a tapered support surface of the fixed support. The disc includes first and second walls axially displaced outwardly relative to the first wall, and the second wall is contiguous with the cylindrical support surface.

### SUMMARY

The present disclosure provides an encoder for a wheel bearing of a vehicle which is simple to manufacture and dimensionally stable. Example embodiments result from the following description and the attached figures.

An encoder for a wheel bearing includes a carrier plate ring having a radially running first leg and an axially running second leg. The axially running second leg of the carrier plate ring is arranged on an outer ring or on an inner ring of the wheel bearing. The carrier plate ring is at least partly surrounded by a magnetic encoding ring and has, on the radially running first leg, cut-outs distributed over the circumference. The first leg has a fold for forming a folded portion, and the folded portion of the first leg at least partly covers the cut-outs. The encoding ring has unipolar magnetization and at least partly contacts the cut-outs. In other words, the carrier plate ring is at least partially encased or overmolded with the material of the magnetic encoding ring. The encoding ring may be bonded to the carrier plate ring by means of a chemical bonding system, for example by means of vulcanization. Thus, the encoding ring is at least partially materially connected to the carrier plate ring with a material bond.

In accordance with an exemplary embodiment, the carrier plate ring is substantially L-shaped in cross-section and is formed from a metal, having a first leg and a second leg. The first leg runs substantially radially and the second leg runs substantially axially. Further, the radially oriented first leg is designed to be folded so that a folded portion is integrally formed therewith. In other words, the first leg is folded or has a fold at an application-dependent radial position, so that the radial end of the first leg or the folded portion points in the direction of the axially aligned second leg after a forming or folding operation. Consequently, the first leg and the folded portion of the first leg are axially adjacent to one another and are integrally connected via the fold. In other words, the radially running first leg and the folded portion are arranged substantially parallel to one another. The first and second legs are further arranged relative to one another in such a manner that a substantially right angle is created between the legs. The carrier plate ring may be ferromagnetic.

The carrier plate ring is pressed onto the respective rotatable ring in the wheel bearing, which may be the inner ring or the outer ring of the wheel bearing depending on the application, or arranged in a stationary manner, meaning axially fixed and non-rotatable, using an alternative suitable method. In contrast, in the example of the L-shaped carrier plate ring, the radially running first leg extends spatially between the inner and outer rings in the radial direction, and the encoding ring is substantially connected to the first leg and acts together with a sensor device.

The sensor device can include one or more sensor elements, such as a speed sensor, and the sensor elements can be based on different physical principles of operation.

The term “unipolar magnetized encoder” refers to an encoder whose magnetized material has only a single polarity. Depending on the spatial direction of the measured magnetic flux density, a polarity change takes place. If magnetization is measured in the x-direction, i.e., in the circumferential direction of the carrier plate ring, the measurement signal is symmetrical about the 0-point. In other words, there is a 0-point symmetrical course of a magnetic flux density component so that a polarity change occurs. However, if magnetization is measured in the z-direction, i.e., perpendicular to the radially running first leg or to the encoding ring surface, the encoding ring exhibits a single magnetization applied in only one direction over the entire circumference, which varies in intensity due to the changing material thickness of the encoding ring caused by the cut-outs.

To generate the magnetization of the encoding ring, a magnetization tool or magnetization head is used which has, for example, a cylindrical base and generates a unipolar magnetization on the encoding ring. Such a magnetization tool is comparatively simple to design and manufacture, compared to magnetization tools intended for the production of multi-pole encoders. This makes it possible to use a single magnetization tool regardless of the size of the encoder or the number of increments. Elastomers and thermoplastics enriched with appropriate magnetic filler, e.g., strontium ferrite SrFe, are suitable materials for the encoding ring.

The cut-outs formed on the radial first leg can be distributed evenly or unevenly over the entire circumference of the first leg, depending on the requirements. The cut-outs are thus formed as openings or windows in which the encoding ring at least partially engages. The cut-outs may be completely filled or closed by the material of the encoding ring. Thus, several cut-outs are arranged circumferentially distributed on the radial first leg, and the encoding ring is formed in a perforated manner.

The encoding ring may be arranged over the entire circumference of the carrier plate ring. Depending on the application, it is also conceivable to interrupt the encoding ring and thus arrange it in sections around the circumference of the carrier plate ring. In addition, it is conceivable to further guide or arrange the material of the encoding ring up to the seat of the axially running leg of the carrier plate ring on the inner ring or on the outer ring in order to improve the static sealing effect on the press fit.

The cut-outs on the radial first leg may be produced by punching before the fold and thus the folded portion of the radially running first leg are created by forming. The folded portion of the radially running first leg may be configured to form a counter face for a sealing lip of a sealing element. In other words, the folded portion is configured in such a manner that, in operation, at least one sealing lip of a sealing element comes into contact with the folded portion in a sealing manner. For this purpose, the respective sealing lip is essentially axially aligned and nestles against the counter face of the folded portion. Consequently, the folded portion is arranged on a side of the radially running first leg facing the axially running second leg. In other words, the folded portion is arranged on a side of the radial first leg facing the sealing element and axially comes into contact with the radially running first leg. Consequently, the radially running first leg is arranged essentially parallel to the folded portion.

Due to the fact that the carrier plate ring of the encoder can be produced by punching and forming, the encoder can be manufactured simply and inexpensively without further machining or forming steps. In addition, the dimensional stability and sealing effect is not limited. Furthermore, the encoder requires less axial installation space. The first leg and/or the folded portion may be subjected to a surface treatment by forming in the region of the contact or sliding surface of the sealing element before or after forming the fold in order to reduce friction between the carrier plate ring of the encoder and the sealing element and to increase the sealing effect.

Accordingly, the radially running first leg and/or the folded portion is surface-treated at least in sections. The surface treatment may include a reduction of the surface roughness.

According to an exemplary embodiment, the fold is formed on the radially running first leg in the region of the cut-outs. By turning over or folding the radially running first leg in the region of the cut-outs, a tooth-like structure is initially formed on the outer circumference of the carrier plate ring, wherein the intertooth spaces are formed by the cut-outs and the teeth are formed by the radial first leg, the fold and the folded portion abutting the first leg. The radial position of the fold is selected such that the folded portion of the carrier plate ring at least partially covers the part of the cut-out on the radially running first leg. In other words, the fold always forms the radially outermost point of the carrier plate ring.

Alternatively, the fold formed on the radially running first leg is formed on a side of the cut-outs facing away from the axially running second leg. In other words, the radial position of the fold is selected such that the radial section of the carrier plate ring at least partially covers the cut-out present on the radial first leg. In other words, after forming the radial leg, part of the cut-out remains as a through opening, and the size of the opening depends on the radial position of the fold. This opening is at least partially filled by the material of the encoding ring after a manufacturing step of the encoding ring. In this case, the radially outer diameter of the carrier plate ring is larger than in the alternative case when the fold is formed on the radially running first leg in the region of the cut-outs.

The encoding ring may have an axially running leg. The axially running leg is integrally connected to the material of the encoding ring which at least partially engages in the cut-outs and is radially spaced apart from and substantially parallel to the axially running second leg of the carrier plate ring. In addition, the axially running leg of the encoding ring can be oriented in the same direction as the axially running second leg of the carrier plate ring so that the encoder has a substantially C-shaped structure. The axial leg of the encoding ring is formed in conjunction with the sealing element, e.g., to form a labyrinth chamber. A so-called pre-sealing labyrinth is thus formed, which increases the service life of the sealing element arranged in the wheel bearing.

An encoder according to a further embodiment includes a carrier plate ring having a radially running first leg and an axially running second leg. The axially running second leg of the carrier plate ring is arranged on an outer ring or on an inner ring of the wheel bearing, and the carrier plate ring is at least partly surrounded by a magnetic encoding ring. A window plate ring with cut-outs distributed over the circumference is fastened to the radially running first leg of the carrier plate ring, and the encoding ring has unipolar magnetization and at least partly comes into contact in the cut-outs of the window plate ring. In other words, the carrier plate ring as well as the window plate ring are at least partially encased or overmolded with the material of the magnetic encoding ring. The encoding ring may be bonded to the carrier plate ring and to the window plate ring by means of a chemical bonding system, for example by means of vulcanization. The encoding ring is thus at least partially materially connected to the carrier plate ring and the window plate ring with a material bond. Thus, the window plate ring is connected to the carrier plate ring in a stationary manner, meaning axially fixed and non-rotatable, via the material of the encoding ring, which engages at least partially in the cut-outs of the window plate ring.

One difference from the previous embodiments is that the carrier plate ring has at least one radially running first leg and one axially running second leg, and, in this case, a fold of the radial first leg as well as punching of the carrier plate ring can be omitted. However, a punched window plate ring is arranged in a non-rotatable manner on the radial leg, which receives the material of the encoding ring, which, according to the previous embodiments, also comes into contact with the carrier plate ring and is connected thereto. This further simplifies the manufacture of the carrier plate ring, as a fold is not required in this case.

The carrier plate ring may have an axially running third leg. The axially running third leg of the carrier plate ring is integrally connected to the first and second legs and is radially spaced apart, i.e. arranged substantially parallel to the axially running second leg of the carrier plate ring. In addition, the axially running third leg of the carrier plate ring can be oriented in the same direction as the axially running second leg of the carrier plate ring so that the carrier plate ring has a substantially C-shaped structure. The axially running third leg of the carrier plate ring is formed in conjunction with the sealing element, e.g., to form a labyrinth chamber. A so-called pre-sealing labyrinth is thus formed, which increases the service life of the sealing element arranged in the wheel bearing.

The window plate ring may be arranged on a side of the radial first leg facing away from the sealing element so that an uninterrupted sealing surface for the sealing lip of the sealing element is provided by the radial leg of the carrier plate ring and the window plate ring is thus located on the rear side of the radially running first leg.

A wheel bearing according to the present disclosure includes an encoder of one of the types described above. The encoder is arranged in a non-rotatable manner on either an outer peripheral surface of an outer ring or on an inner peripheral surface of an outer ring. It is conceivable that the encoding ring and/or the carrier plate ring at least partly comes into contact with an end face of the inner or outer ring and/or is at least partially received in a depression or recess of the respective component. Furthermore, such an encoder can also be provided for alternative bearing elements, and a displaceable or rotatable component on which the encoding ring is arranged can be displaced or rotated relative to a stationary fixed component. For example, it is conceivable to provide the encoder for a linear bearing.

The encoding ring can be magnetized before mounting on the inner or outer ring. Alternatively, due to the comparatively simple magnetizability of the encoding ring, it is also conceivable to carry out single-pole magnetization after mounting the encoder in the wheel bearing. In this case, no dirt can accumulate until the time of magnetization, which would negatively affect the magnetization. Overall, the unipolar magnetization of the encoding ring exerts a comparatively low attraction on ferromagnetic (dirt) particles or contaminants.

The above definitions and explanations of technical effects and embodiments of the respective encoder also apply mutatis mutandis to the wheel bearing.

### BRIEF DESCRIPTION OF THE DRAWINGS

The present disclosure is described below together with a description of three exemplary embodiments using the figures, wherein identical or similar elements are marked with the same reference numeral. In the figures:

FIG. 1 shows a schematic sectional view illustrating the structure of a partially shown wheel bearing according to the disclosure with an encoder according to the disclosure in accordance with a first embodiment,

FIG. 2a shows a schematic perspective view of the encoder according to a second embodiment,

FIG. 2b shows a schematic cross-sectional view of the encoder according to FIG. 2a,

FIG. 2c shows a perspective cross-sectional view of the encoder according to FIGS. 2a and 2b.

FIG. 2d shows a further perspective cross-sectional view of the encoder according to FIGS. 2 to 2c,

FIG. 3a shows a schematic perspective view of the partially shown encoder according to FIG. 1.

FIG. 3b shows a schematic cross-sectional view of the encoder according to FIGS. 1 and 3a,

FIG. 3c shows a further schematic cross-sectional view of the encoder according to FIGS. 1, 3a and 3b,

FIG. 3d shows a perspective cross-sectional view of the encoder according to FIGS. 1 and 3a to 3c,

FIG. 3e shows a further perspective cross-sectional view of the encoder according to FIGS. 1 and 3a to 3d, and

FIG. 4 shows a schematic cross-sectional view of the encoder according to the disclosure according to a third embodiment.

### DETAILED DESCRIPTION

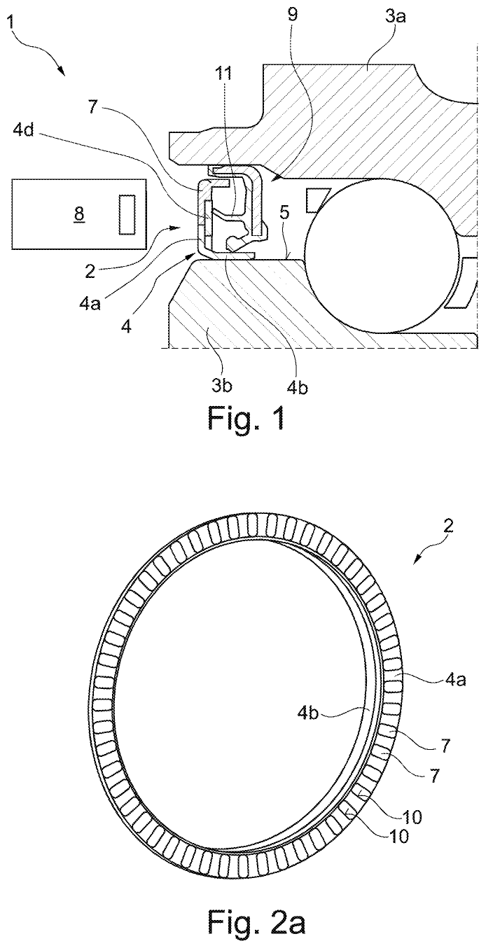

According to FIG. 1, a wheel bearing 1 for a vehicle, not shown here, has an encoder 2. The encoder 2 is arranged in a non-rotatable and axially fixed manner on an outer peripheral surface 5 of an inner ring 3b of the wheel bearing 1 designed as an angular contact ball bearing. In particular, the encoder 2 includes a substantially L-shaped carrier plate ring 4 and a magnetized encoding ring 7 partially arranged thereon by overmolding. The encoder 2 interacts with a sensor device 8, for example for the purpose of speed measurement.

The carrier plate ring 4 has a first radially running leg 4a and a second axially running leg 4b. The axial second leg 4b is arranged on the inner ring 3b of the wheel bearing 1 in a non-rotatable and axially fixed manner. The radial first leg 4a extends in a radial direction towards the outer ring 3a and is folded at a fold 15 so that a folded portion 4d of the first leg 4a extends in the opposite radial direction towards the inner ring 3b and abuts axially against the radial first leg 4a. Consequently, the folded portion 4d is arranged parallel to the first leg 4a. In the present case, the folded portion 4d is arranged on a side of the radially running first leg 4a facing the axially running second leg 4b.

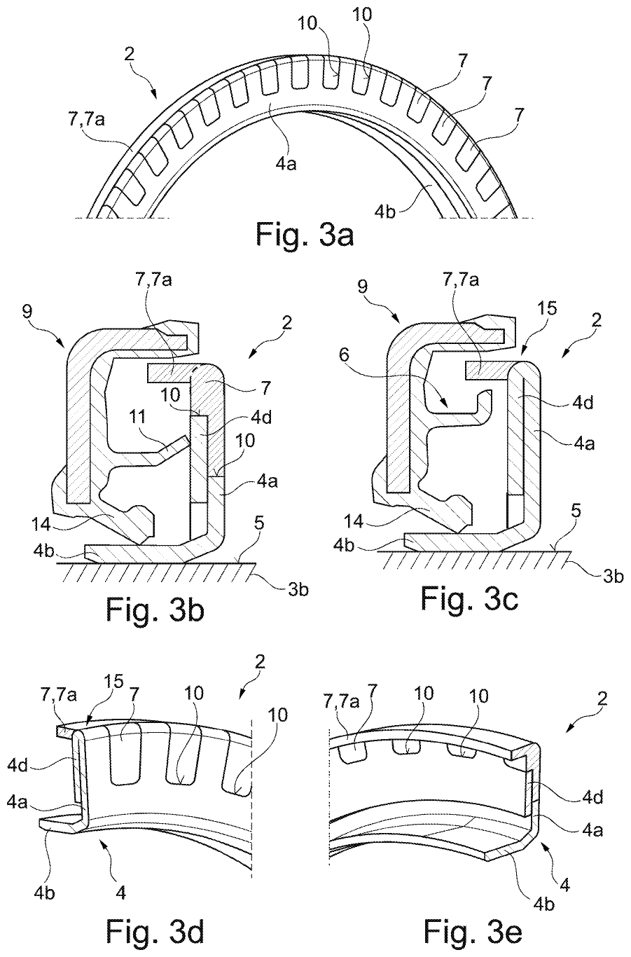

The carrier plate ring 4 has cut-outs 10 distributed around the circumference on the radially running first leg 4a, which result in a different design of the carrier plate ring 4 depending on the radial position of the fold 15. The fold 15 is made after punching the cut-outs 10. In the embodiments according to FIGS. 1 to 3e, the radial position of the fold 15 is provided such that the folded portion 4d of the first leg 4a at least partially covers the cut-outs 10. The folded portion 4d of the radially running first leg 4a is designed in particular to form a counter face for a substantially axially extending sealing lip 11 of a sealing element 9. Furthermore, a further sealing lip 14 can come into contact radially with the axially running second leg 4b to form a seal, as shown by way of example in FIGS. 3b and 3c respectively. The design of the sealing element 9 is, of course, readily transferable to all embodiments.

The encoding ring 7 is formed over the entire circumference of the first leg 4a of the carrier plate ring 4. The encoding ring 7 is unipolarly magnetized before or after it is mounted in the wheel bearing 1 and at least partly comes into contact in the cut-outs 10 of the carrier plate ring 4. Consequently, the material of the encoding ring 7 at least partially fills the space of the cut-outs 10, and the encoding ring 7 is supported on the corresponding walls of the cut-outs 10.

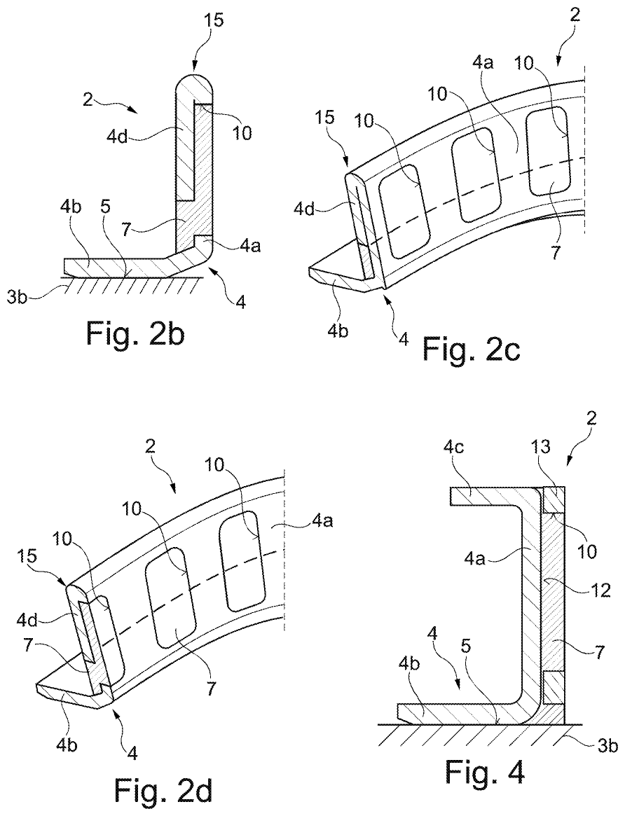

According to FIGS. 2a to 2d, the fold 15 is formed according to a second embodiment on a side of the cut-outs 10 facing away from the axially running second leg 4b. In other words, the fold 15 is formed radially outside the cut-outs 10, and the folded portion 4d covers the cut-outs 10 only partially, i.e., not completely. Thus, the cut-outs 10 are spatially connected to a space between the tip of the folded portion 4d and the axially running second leg 4b, and this space, as well as the space of the cut-outs 10, is completely filled with the material of the encoding ring 7. The fold 15 forms the radially outermost point of the carrier plate ring 4.

FIGS. 2c and 2d show different cross-sections through the encoder 7. It is intended to show here that the material of the encoding ring 7 extends over the entire circumference of the carrier plate ring 4 on the axial leg side or sealing element side, and the material of the encoding ring 7 engages in the cut-outs 10 in the regions of the cut-outs 10 and fills them completely. Consequently, the encoding ring 7 comes into contact with the cut-outs 10. On the one hand, this prevents a relative movement between the carrier plate ring 4 and the encoding ring 7. On the other hand, the encoding ring 7 has a magnetized layer with varying material thickness, and an alternating magnetic field of the same polarity is consequently formed on its surface. Depending on requirements, the cut-outs 10 can be evenly or unevenly distributed around the circumference of the carrier plate ring 4. Furthermore, the cut-outs 10 can have a substantially rectangular shape or a substantially circular shape. Furthermore, the longer sides of the cut-outs 10 may extend substantially radially.

According to the first embodiment of the encoder 2 also shown in FIG. 1 according to FIGS. 3a to 3e, one difference from the second embodiment according to FIGS. 2 to 2d is that the fold 15 is formed on the radially running first leg 4a in the region of the cut-outs 10. The carrier plate ring 4 therefore has a tooth-shaped structure on its outer peripheral surface into which the material of the encoding ring comes into contact. The fold 15 forms the radially outermost point of the carrier plate ring 4. The radial position of the fold 15 is selected such that the folded portion 4d of the carrier plate ring 4 partially covers the part of the cut-out 10 on the radially running first leg 4a.

Furthermore, the encoding ring 7 has an axially running leg 7a. The axially running leg 7a is integrally formed on the material of the encoding ring 7 received in the cut-outs 10 and is radially spaced apart from and substantially parallel to the axially running second leg 4b of the carrier plate ring 4. In addition, the axially running leg 7a of the encoding ring 7 is aligned in the same direction as the axially running second leg 4b of the carrier plate ring 4 so that the encoder 2 has a substantially C-shaped structure. A pre-sealing labyrinth is formed through the axial leg 7a of the encoding ring 7 in order to make it more difficult or delay the ingression of dirt and/or moisture to the sealing element 9 and thereby increase the service life of the sealing element 9, for example.

As already indicated, FIGS. 3b and 3c each show a sealing element 9 that in both cases comes into contact with the axially running second leg 4b via the sealing lip 14 to form a seal. The sealing element 9 shown in FIG. 3b also has a sealing lip 11 which comes into contact with the folded portion 4d in a substantially axially sealing manner. The folded portion can be surface treated in the area of contact with the sealing lip 11 to increase the service life of the sealing element 9. The sealing element 9 is arranged in a non-rotatable and axially fixed manner on the outer ring 3b shown in FIG. 1.

The sealing element 9 as shown in FIG. 3c has a pocket 6 instead of the sealing lip 11 to catch dirt and/or moisture and prevent dirt and/or moisture from reaching the contact surface between the carrier plate ring 4 and the sealing lip 14.

FIGS. 3d and 3e show different cross-sections through the encoder 7. It is intended to show here that the material of the encoding ring 7 extends over the entire circumference of the carrier plate ring 4 on the axial leg side or sealing element side over the axial leg 7a of the encoding ring 7, and the material of the encoding ring 7 engages in the cut-outs 10 in the regions of the cut-outs 10 and fills them completely. Consequently, the encoding ring 7 comes into contact with the cut-outs 10. On the one hand, this prevents a relative movement between the carrier plate ring 4 and the encoding ring 7. On the other hand, the encoding ring 7 has a magnetized layer with varying material thickness, and an alternating magnetic field of the same polarity is consequently formed on its surface.

According to FIG. 4, the encoder 2 according to a third exemplary embodiment includes a carrier plate ring 4 with a radially running first leg 4a, an axially running second leg 4b and an axially running third leg 4c. The two axially running legs 4b, 4c are radially spaced apart and point in the same direction, so that the encoder is formed to be essentially C-shaped. The carrier plate ring 4 is arranged with the axially running second leg 4b on an inner ring 3b of the wheel bearing 1, analogously to the previous embodiments, and is partially surrounded by a magnetic encoding ring 7 in the region of the radially running first leg 4a on an end face 12. Also fastened to the radially running first leg 4a of the carrier plate ring 4 is a window plate ring 13 with cut-outs 10 distributed over its circumference, which is connected to the carrier plate ring 4 in a non-rotatable manner via the material of the encoding ring 7. The encoding ring 7 is unipolarly magnetized and comes into contact in the cut-outs 10 of the window plate ring 13. Furthermore, the material of the encoding ring 7 is guided to the interference fit between the inner ring 3b and the axially running third leg 4c to improve the static sealing effect. This is analogously transferable to the previous embodiments.

In this case, the task of the axial leg 7a of the encoding ring 7 according to the second exemplary embodiment is taken over by the axially running third leg 4c, and a sealing lip, not shown here, can come into contact with the radially running first leg 4a in a sealing manner.

For all embodiments, it is also conceivable that the carrier plate ring 4 is arranged in a non-rotatable and axially fixed manner on the outer ring 3a shown in FIG. 1. In this case, the sealing element 9 is arranged on the inner ring 3a shown in FIG. 1 in a non-rotatable and axially fixed manner.

### REFERENCE NUMERALS

1 Wheel bearing
2 Encoder
3a Outer ring
3b Inner ring
4 Carrier plate ring
4a First leg of the carrier plate ring
4b Second leg of carrier plate ring
4c Third leg of the carrier plate ring
4d Folded portion of carrier plate ring
5 Outer peripheral surface
6 Pocket
7 Encoding ring
7a Axial leg of the encoding ring
8 Sensor device
9 Sealing element
10 Cut-out
11 Sealing lip
12 End face
13 Window plate ring
14 Second sealing lip
15 Fold

1. An encoder for a wheel bearing, comprising a carrier plate ring having a radially running first leg and an axially running second leg, the axially running second leg of the carrier plate ring being arranged on an outer ring or on an inner ring of the wheel bearing, the carrier plate ring being at least partly surrounded by a magnetic encoding ring, wherein:
the carrier plate ring has, on the radially running first leg, cut-outs distributed over its circumference,
the radially running first leg has a fold for forming a folded portion,
the folded portion of the radially running first leg at least partly covers the cut-outs, and
the magnetic encoding ring has unipolar magnetization and at least partly comes into contact in the cut-outs.

2. The encoder according to claim 1, wherein:
the folded portion of the radially running first leg is configured to form a counter face for a sealing lip of a sealing element.

3. The encoder according to claim 1, wherein:
the encoding ring is arranged over an entire circumference of the carrier plate ring.

4. The encoder according to claim 1, wherein:
the fold is formed on the radially running first leg in a region of the cut-outs.

5. The encoder according to claim 1, wherein:
the fold is formed on the radially running first leg on a side of the cut-outs facing away from the axially running second leg.

6. The encoder according to claim 1, wherein:
the radially running first leg or the folded portion is surface-treated at least in sections.

7. The encoder according to claim 1, wherein:
the encoding ring has an axially running leg.

8. An encoder for a wheel bearing, comprising a carrier plate ring having a radially running first leg and an axially running second leg, the axially running second leg of the carrier plate ring being arranged on an outer ring or on an inner ring of the wheel bearing, the carrier plate ring being at least partly surrounded by a magnetic encoding ring, wherein:
a window plate ring with cut-outs distributed over its circumference is fastened to the radially running first leg of the carrier plate ring, and
the encoding ring has unipolar magnetization and at least partly comes into contact in the cut-outs of the window plate ring.

9. The encoder according to claim 8, wherein:
the carrier plate ring has an axially running third leg.

10. A wheel bearing comprising an encoder according to claim 1, wherein the encoder is arranged in a non-rotatable manner on an outer peripheral surface of the outer ring or an inner peripheral surface of the outer ring.

11. An encoder for a wheel bearing, comprising:
a carrier plate ring comprising:
a radially running first leg comprising:
a first circumference;
cut-outs distributed over the first circumference; and
a fold for forming a folded portion, the folded portion at least partly covering the cut-outs;
an axially running second leg arranged on an outer ring or an inner ring of the wheel bearing; and
a magnetic encoding ring having unipolar magnetization, the magnetic encoding ring:
at least partially surrounding the carrier plate ring; and
at least partly coming into contact in the cut-outs.

12. The encoder of claim 11 further comprising a sealing element having a sealing lip, wherein the folded portion forms a counter face for the sealing lip.

13. The encoder of claim 11, wherein:
the carrier plate ring comprises a second circumference; and
the encoding ring is arranged over an entirety of the second circumference.

14. The encoder of claim 11, wherein:
the radially running first leg comprises a cut-out region;
the cut-outs are arranged in the cut-out region; and
the fold is formed on the radially running first leg in the cut-out region.

15. The encoder of claim 11, wherein:
the radially running first leg comprises a first side;
the first side is a side of the cut-outs facing away from the axially running second leg; and
the fold is formed on the first side.

16. The encoder of claim 11, wherein the radially running first leg or the folded portion is surface-treated at least in sections.

17. The encoder of claim 11, wherein the encoding ring comprises an axially running leg.
